(19) United States
(12) Patent Application Publication
(10) Pub. No.: US 2006/0279762 A1
(43) Pub. Date: Dec. 14, 2006

(54) Document processing system, printing system, document file, document processing method and computer program product

(75) Inventor: Takeshi Onishi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO, LTD.

(21) Appl. No.: 11/261,757

(22) Filed: Oct. 31, 2005

(30) Foreign Application Priority Data
Jun. 10, 2005 (JP) P2005-171710

(51) Int. Cl. G06K 15/00; G06F 15/00

(52) U.S. Cl. 358/1.14; 358/3.28

(57) ABSTRACT

A document processing system includes a document acquiring unit that acquires document data, an information acquiring unit that acquires information used to generate a code image printed with an image of the document data on a medium, and a file generating unit that generates an information-added document file by adding the information used to generate the code image to the document data.

### BACKGROUND OF THE INVENTION

1. Field of the Invention

The present invention relates to a document processing system for processing document data, a printing system for printing an image based on document data, and a document file including document data.

2. Description of the Related Art

Recently, much attention has been paid to a technique for writing characters or diagrams on a particular paper on which fine dots are printed, transmitting the characters or the like written on the paper by a user to a personal computer or a mobile phone, and capable of preserving or mailing the contents therein. In the technique, small dots are printed in an interval of, for example, 0.3 mm on the particular paper, and for example, the dots constitute different patterns in corresponding grids having a predetermined size. By reading the paper with a dedicated pen having, for example, a built-in digital camera, positions of the characters or the like written on the particular paper can be specified, and the characters or the like can be used as electronic information.

There is a related technique for binding an electronic document and a paper on which the electronic document is printed with a string and integrating characters or the like written on the paper with the electronic document.

In the technique described above, identification information on electronic document pages and position information on the paper are buried in a code image, of which representative one is machine-readable two-dimensional code or the like, and then, overlapped with the electronic document and printed by a printer or the like. Next, by using a pen type scanner, writing motion on the printed document and partial images of writing positions is continuously acquired from the printed document. Next, by analyzing the acquired image, a plurality of position information of the identification information of the electronic document pages and the partial image is detected. After that, the original electronic document pages is identified by using the detected identification information, and at the same time, the contents written on the printed document is reproduced by using a plurality of position information, so that it is possible to add the written contents to the original electronic document pages.

In addition, in another related art, at the time of printing an electronic document, identification information previously distributed on a medium is read, and the electronic document and the identification information are managed by a server or the like. Next, a code image buried together with an image of the electronic document is detected with a pen-type scanner. Next, by analyzing the code image, the identification information associated with the electronic document and position information on the printed document read with the pen-type scanner are acquired. After that, an original electronic document is specified based on the identification information, and handwriting information performed on the printed document is reproduced at positions corresponding to the electronic document.

### SUMMARY OF THE INVENTION

However, in the technique described above, at the time of printing the electronic document, the identification information of electronic document pages is acquired through a query to a document managing database. In addition, in another technique described above, since different identification information is previously distributed to media, there is a need for a process for reading the identification information from the medium at the time of printing the electronic document.

Therefore, in any related arts, at the time of printing the electronic document, there is a problem in that there is a need for a complicated process for acquiring information used to generate the code image which is to be printed together with the document image of the electronic document.

The present invention has been made in view of the above circumstances and provides a document processing system. According to an aspect of the present invention, there is provided a document processing system comprising: a document acquiring unit that acquires document data; an information acquiring unit that acquires information used to generate a code image printed together with an image of the document data on a medium; and a file generating unit that generates an information-added document file by adding the information used to generate the code image to the document data.

According to another aspect of the invention, there is provided with a printing system for forming an image by acquiring a document file having the aforementioned information. The printing system includes: a document acquiring unit that acquires a document file formed by adding information to document data; an information extracting unit that extracts the information from the document file; a code image generating unit that generates a code image by using the information extracted by the information extracting unit; a document image generating unit that generates a document image based on the document data included in the document file; and an image forming unit that forms an image by combining the code image with the document image.

According to still another aspect, there is provided with an information-added document file having the aforementioned information. The document file includes: first data which is a basis of a document image; and second data which is converted in a machine-readable code image at the time of printing the document image on a medium and printed together with the document image, wherein the first data and the second data are simultaneously read to be used for printing.

According to further still another aspect, there is provided with a method of adding information used to generate a code image to an electronic document (document data). A document processing method includes: acquiring document data; acquiring information used to generate a code image printed together with an image of the document data on a medium; and generating information-added document file by adding the information used to generate the code image to the document data.

According to further still another aspect, a storage medium readable by a computer and storing a program of instructions executable by the computer to perform predetermined function on a computer the function including: acquiring document data; acquiring information used to generate a code image printed together with an image of the document data on a medium; and generating an information-added document file by adding the information used to generate the code image to the document data.

### BRIEF DESCRIPTION OF THE DRAWINGS

FIG. 1 is a view showing a whole construction of a system to which an embodiment of the present invention is applied.

FIG. 2 is a view showing a functional construction associated with document file generation of a document managing server and an identification information managing server according to an embodiment of the present invention.

FIG. 3 is a flowchart showing operations associated with document file generation of a document managing server according to an embodiment of the present invention.

FIG. 4 is a flowchart showing operations associated with registration of identification information and the like of an identification information managing server according to an embodiment of the present invention.

FIGS. 5A-5B are views for explaining management of position information according to an embodiment of the present invention.

FIG. 6 is a view showing an example of contents stored in a correspondence information DB according to an embodiment of the present invention.

FIG. 7 is a view showing a construction of a document file according to an embodiment of the present invention.

FIG. 8 is a view showing a functional construction associated with image generation of an identification information managing server according to an embodiment of the present invention.

FIG. 9 is a flowchart showing operations associated with image generating of an identification information managing server according to an embodiment of the present invention.

FIGS. 10A-10C are views for explaining a two-dimensional code image printed on a medium according to an embodiment of the present invention.

FIG. 11 is a view showing a functional construction associated with document transmitting command generation of an identification information managing server according to an embodiment of the present invention.

### DESCRIPTION OF THE EMBODIMENTS

Now, best modes for carrying out the present invention (hereinafter, referred to as embodiments) will be described in detail with reference to the accompanying drawings.

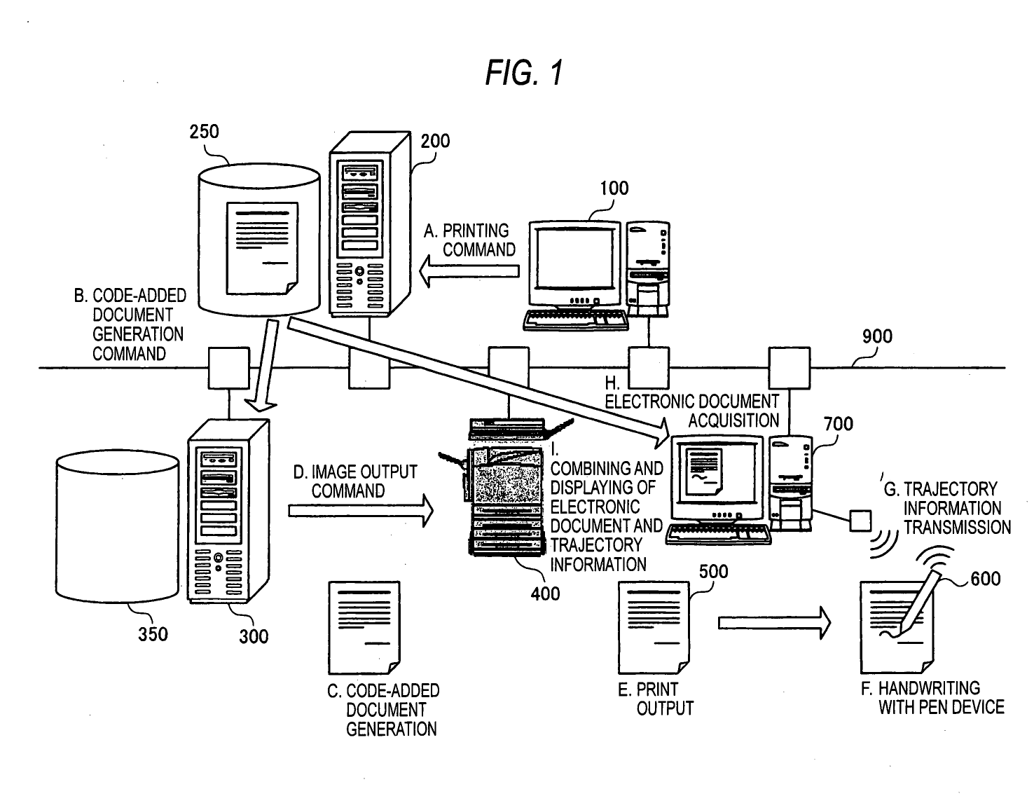

FIG. 1 shows a construction of a system according to an embodiment. The system is configured by connecting at least a terminal apparatus 100 for commanding printing of an electronic document, a document managing server 200 for managing a to-be-printed electronic document, an identification information managing server 300 for generating a code-added document where a code image indicating identification information is added to a document image of the printing-commanded electronic document, and an image forming apparatus 400 for printing the code-added document with a network 900.

A document repository 250 which is a storage unit for storing the electronic document is connected to the document managing server 200, and an identification information repository 350 which is a storage unit for storing the identification information for identifying pages of the electronic document is connected to the identification information managing server 300.

In addition, the system comprises a code-image-added paper 500 output from the image forming apparatus 400 and a pen device 600 for writing characters or diagrams on the code-image-added paper 500 and reading writing information of the characters or the diagram. In addition, a terminal apparatus 700 for overlapping and displaying the document managed by the document managing server 200 and the writing information read by the pen device 600 is also connected to the network 900.

Now, operations of the system will be described in brief.

Firstly, the terminal apparatus 100 commands the document managing server 200 to print a specific electronic document managed in the document repository 250 (A).

By doing so, the document managing server 200 transmits the printing-commanded electronic document to the identification information managing server 300 and commands the identification information managing server 300 to generate the code-added document by adding a code image indicating identification information or the like to the document image of the electronic document (B). The commanded identification information managing server 300 generates the code-added document for the document image of the commanded electronic document by adding the code image indicating identification information or the like managed in the identification information repository 350 (C).

In addition to identification information, the information added to a code image includes position information for specifying a coordinate position (X coordinate and Y coordinate) on a paper or additional information used for a user application (hereinafter, referred to as “user AP”) Next, the identification information managing server 300 commands the image forming apparatus 400 to output an image of the code-added document (D). By doing so, the image forming apparatus 400 outputs the code-image-added paper 500 (E).

In addition, as described later in detail, the image forming apparatus 400 forms the code image added in the identification information managing server 300 as an invisible image by using an invisible toner and the other images (images included in an original electronic document) as a visible image by using a visible toner.

After that, a user writes (hand-writes) characters or diagrams on the code-image-added paper 500 with the pen device 600 (F). By doing so, an image pickup device of the pen device 600 picks up a predetermined region of the code-image-added paper 500 to acquire the position information, the identification information, and the additional information. Next, trajectory information of the characters or the diagrams acquired form the position information, the identification information, and the additional information are transmitted to the terminal apparatus 700 in a wire or wireless manner (G). In addition, in the system, a invisible image is formed by using an invisible toner having a infrared light absorbance which is higher than a predetermined reference value, and the invisible image can be read with the pen device 600 which can perform infrared light illuminating and sensing.

By doing so, the terminal apparatus 700 acquires a specific page of a specific electronic document which is an object of printing from the document managing server 200 by using the identification information as a key (H), and combines the page and the trajectory information transmitted from the pen device 600 to perform displaying thereof (I). In addition, the document or the like of a link destination in the position may be accessed based on the commanded position information.

In addition, for example, the additional information is used to determine whether or not access to the electronic document managed by the document managing server 200 is accepted. In the embodiment, the identification information managing server 300 performs the determination. Therefore, finally, although the object electronic document is acquired from the document managing server 200, a query whether or not the access to the electronic document is accepted is sent to the identification information managing server 300 in the embodiment.

However, this construction is one example, and thus, functions of the identification information managing server 300 may be provided to the document managing server 200 or implemented as functions of the image processing units of the image forming apparatus 400. In addition, although the electronic document is described as the printing object in the embodiment, the embodiment can be applied to printing of electronic data, for example, such as a picture image or the like which is not include in the scope of the electronic document.

However, in the above description, it is not described which the identification information, the position information, and the additional information included in the code image printed together with the document image is input from. With respect to the point, in the embodiment, information which is a basis of the code image is added to the electronic document (document data) in advance, and then, it is stored as an information-added document file. In addition, although the position information may be added to the document data, in a case where a printing attribute such as a paper size, direction, contraction/magnification, N-up (a printing for allocating N pages of the electronic document to one page of the paper), and double-sided printing is determined, since the position information corresponding thereto can be simply acquired, the position information is added to the printing attribute in the embodiment.

Firstly, generation of such as information-added document file will be described.

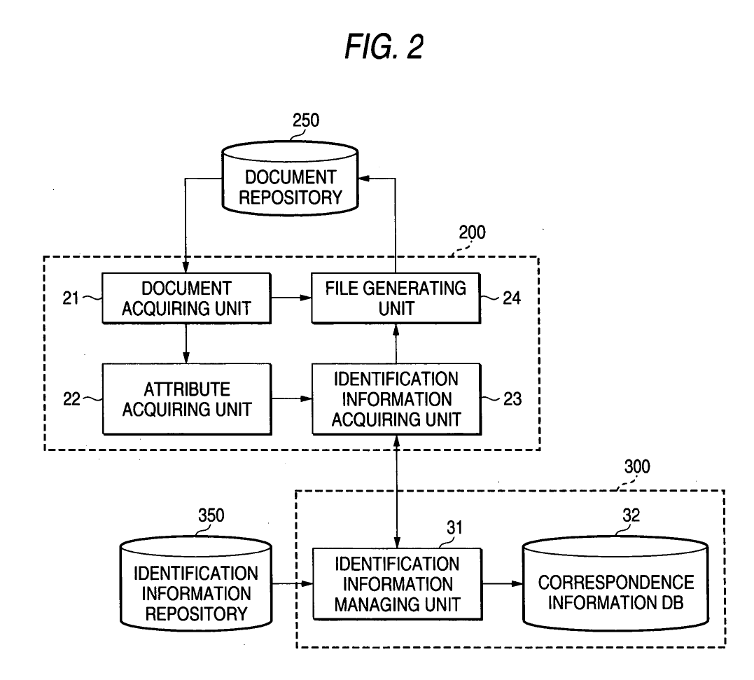

FIG. 2 is a view showing an example of the document managing server 200 and the identification information managing server 300. In addition, for the convenience of description, a document repository 250 and an identification information repository 350 are also shown in the figure.

The document managing server 200 comprises a document acquiring unit 21, an attribute acquiring unit 22, an identification information acquiring unit 23, and a file generating unit 24 In addition, the identification information managing server 300 comprises an identification information managing unit 31 and a correspondence information DB 32.

The document acquiring unit 21 acquires a general-purpose format electronic document (document data) from the document repository 250.

The attribute acquiring unit 22 acquires an attribute (hereinafter, referred to as “document attribute”) for an electronic document and an attribute (hereinafter, referred to as “printing attribute”) for printing, and an attribute (hereinafter, referred to as “right attribute”) for a right to an electronic document medium. Here, the document attribute is exemplified by a storage location of the electronic document and a page number of the electronic document. The printing attribute is exemplified by paper size, direction, contraction/magnification, N-up, and double-sided printing. In addition, the right attribute is exemplified by access limitation (request for inputting user ID and password) to the electronic document, editing allowance/disallowance, and printing allowance/disallowance.

The identification information acquiring unit 23 acquires the attribute information from the attribute acquiring unit 22 and transmits the attribute information to the identification information managing server 300 to request for issuing identification information.

The file generating unit 24 adds the identification information acquired from the identification information managing server 300 to the electronic document to generate an identification information-added document file. In addition, although an output file format may be a general-purpose format, a format capable of prohibiting editing is preferred in order that the identification information, the page number, or the like cannot be changed.

The identification information managing unit 31 generates a required number of identification information by taking the attribute information received from the document managing server 200 into consideration and transmits the identification information to the document managing server 200. In addition, a correspondence between the attribute information and the issued identification information is registered in the correspondence information DB 32. In addition, in terms of managing various information including the identification information, the identification information managing unit 31 may be treated as a managing unit.

The correspondence information DB 32 is a database in which a correspondence between the identification information and the attribute information is registered by the identification information managing unit 31.

The functions are embodied with cooperation of software and hardware resources. More specifically, a CPU (not shown) of the document managing server 200 reads a program for embodying functions of the document acquiring unit 21, the attribute acquiring unit 22, the identification information acquiring unit 23, and the file generating unit 24 from an external memory unit to a main memory unit and executes the program. In addition, a CPU (not shown) of the identification information managing server 300 reads a program for embodying functions of the identification information managing unit 31 from an external memory unit to a main memory unit and executes the program.

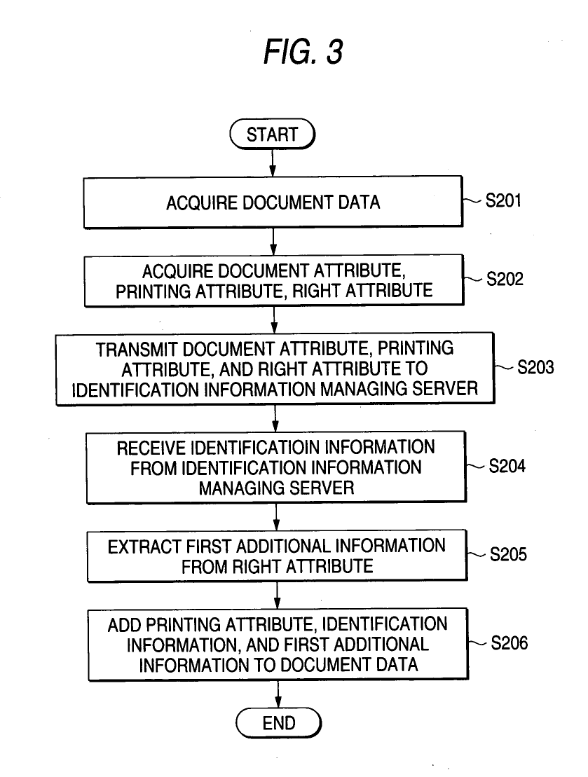

Now, operations of the document managing server 200 will be described with reference to FIG. 3. In addition, the operations are manually driven by a manager of the document managing server 200 designating a specific electronic document. Alternatively, a flag is set to a to-be-processed electronic document, and then, by automatically and periodically driving the document managing server 200, the flag-set electronic document may be processed.

In the document managing server 200, the document acquiring unit 21 firstly acquires the to-be-processed electronic document (document data) (Step 201).

Next, the attribute acquiring unit 22 acquires the document attribute, the printing attribute, and the right attribute (Step 202). Here, among the document attribute, the storage location of the electronic document may be acquired at the time of acquiring the electronic document. In addition, the page number of the electronic document may be acquired by analyzing the electronic document. Since all the techniques related thereto are existing, detail description thereto is omitted. In addition, the printing attribute is determined and input by the user by taking into consideration a printing type of the electronic document printing. Similarly, the right attribute is also determined and input by the user by taking into consideration importance of the electronic document.

Next, if the identification information acquiring unit 23 acquires the document attribute, the printing attribute, and the right attribute from the attribute acquiring unit 22, the identification information acquiring unit 23 transmits the document attribute, the printing attribute, and the right attribute to the identification information managing server 300 (Step 203).

Next, the identification information managing server 300 issues the required number of the identification information and transmits the identification information to the document managing server 200, and the identification information acquiring unit 23 receives the identification information (Step 204).

Next, the file generating unit 24 generates additional information based on the right information (Step 205). In addition, in the embodiment, the additional information includes additional information (hereinafter, referred to as “first additional information”) which can be directly buried as a code image into a medium in a paper and additional information (hereinafter, referred to as “second additional information”) which needs to be registered in a separate database. Since the amount of the information which can be buried in the code image is limited, the information (second additional information) requiring a large amount of information is stored in the database, and then, extracted from the databases according to the information buried in the code image. Therefore, in the step, strictly, since the information used to generate the code image is added, the first additional information is generated.

For example, for example, the right attribute is exemplified by information on whether or not access to the electronic document or the medium is limited and information such as user ID and password which must be input at the time of accessing the electronic document of the medium. The former information may be set as the first additional information, and the latter information may be set as the second additional information.

Finally, the file generating unit 24 adds the printing attribute, the identification information, and the first additional information to the electronic document and generates the identification-information-added document file (Step 206).

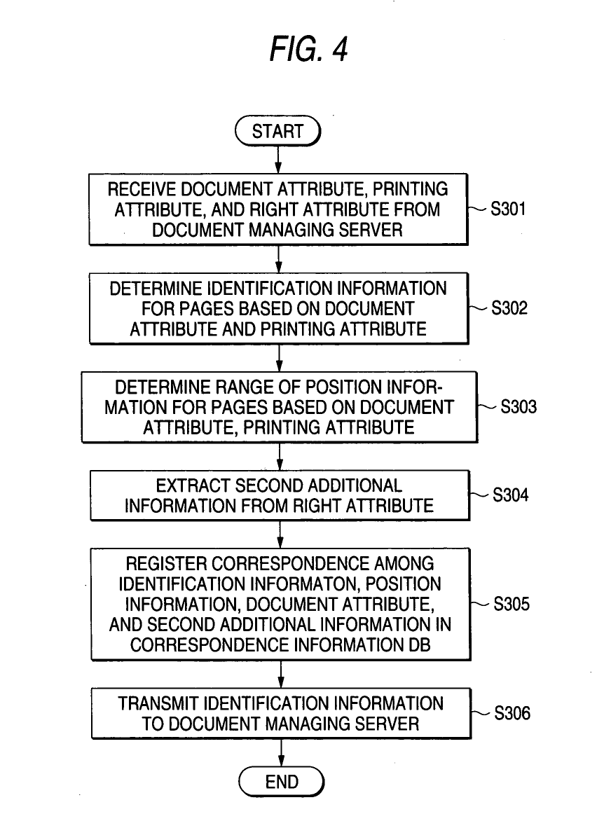

Now, operations of the identification information managing server 300 will be described with reference to FIG. 4. In addition, the operations are the operation of the identification information managing server 300 when the document attribute, the printing attribute, and the right attribute are transmitted in Step 203 in FIG. 3.

In the identification information managing server 300, the identification information managing unit 31 firstly receives the document attribute, the printing attribute, and the right attribute (Step 301).

Next, identification information for each of the pages is determined based on the document attribute and the printing attribute (Step 302). For example, in a case where “N-up” is designated as the printing attribute, if the same identification information intends to be allocated to one medium surface, the same identification information needs to be allocated to N pages of the electronic document. Therefore, if the page number P of the document attribute is designated and “N-up” is designated as the printing attribute, it is preferable to secure P/N (rounded off to decimals) identification information.

Next, a range of the position information is determined based on the document attribute and the printing attribute (Step 303).

In addition, in the embodiment, for simplification of description, a short side direction of the paper is taken as the X axis, and a long side direction of the paper is taken as the Y axis as shown in FIG. 4.

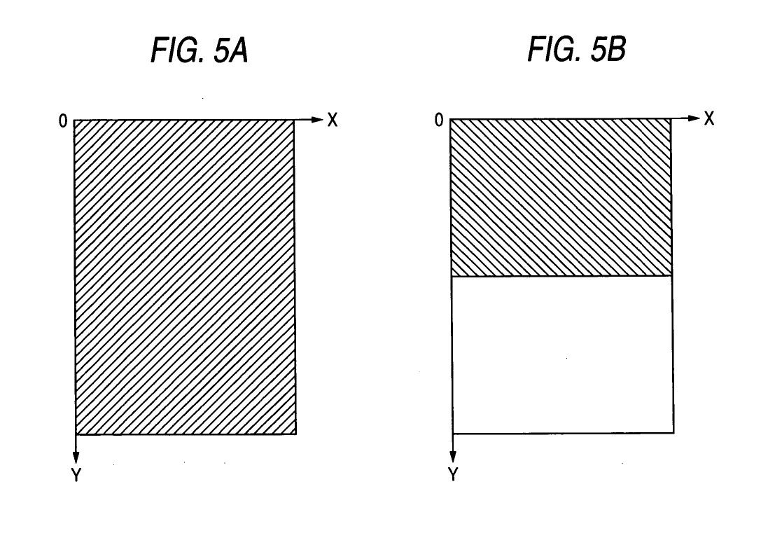

In this case, as shown in FIG. 5A, if “N-up” is not performed, the position code allocated to one page of the electronic document matches with the position code printed on the entire surface of the medium. For example, if the paper size shown in FIG. 5A is A4 size and the interval between the position codes is about 3 mm as described later in detail, although about 70 and about 100 position codes are arranged in the X and Y directions, respectively, all the position codes are secured for one page of the electronic document.

On the other hand, as shown in FIG. 5B, if “2-u” is performed, the electronic document is contracted by 2 pages and arranged in one page of the medium, so that the position codes allocated to each of pages of the electronic document are different from those of the case shown in FIG. 5A. Here, one page of FIG. 5A is printed on an upper half of FIG. 5B. In this case, although about 70 and about 100 position codes are arranged on the medium in the X and Y directions, respectively, about 70 and about 50 position codes in the X and Y directions are sufficient for the position codes representing the range of the upper half of FIG. 5B.

After that, the identification information managing unit 31 extracts the second additional information from the right attribute (Step 304). In the embodiment, the user ID and password which must be input at the time of accessing the electronic document is extracted.

Next, the identification information managing unit 31 registers the identification information, the position information, the document attribute, and the second additional information to the correspondence information DB 32 (Step 306).

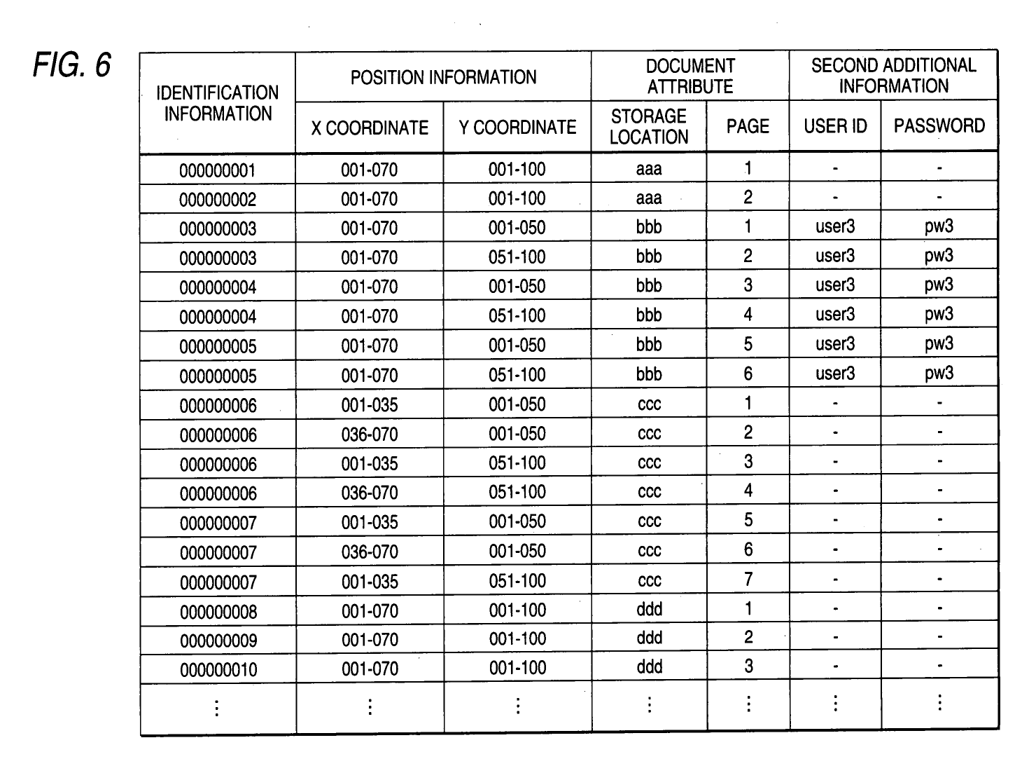

FIG. 6 is a view showing an example of contents stored in the correspondence information DB 32.

As shown in the figure, the correspondence information DB 32 stores a correspondence among the identification information, the position information, the document attribute, and the second additional information.

The position information represents the region occupied by each of the pages on the medium with an X coordinate range and a Y coordinate range. For example, the electronic document in the storage location “bbb” is designated by “2-up” as the printing attribute, so that the same identification information is allocated to two pages. In addition, the electronic document in the storage location “ccc” is designated by “4-up” as the printing attribute, the same identification information is allocated to four pages. However, since there are a total of seven pages, the identification information “000000007” is allocated to three pages.

In addition, the document attribute includes a storage location and a page number of each of the electronic documents.

In addition, as the second additional information, the user ID and password are stored. Namely, if user ID “user 3” and password “pw 3” are input, access to the first to sixth pages of the electronic document in the storage location “bbb” is defined to be accepted.

Returning to FIG. 4, the identification information managing unit 31 transmits the identification information to the document managing server 200 (Step 306).

By doing so, the above-described processes of Steps 204 to 206 of FIG. 3 are performed, and the printing attribute, the identification information, and the additional information are added to the electronic document.

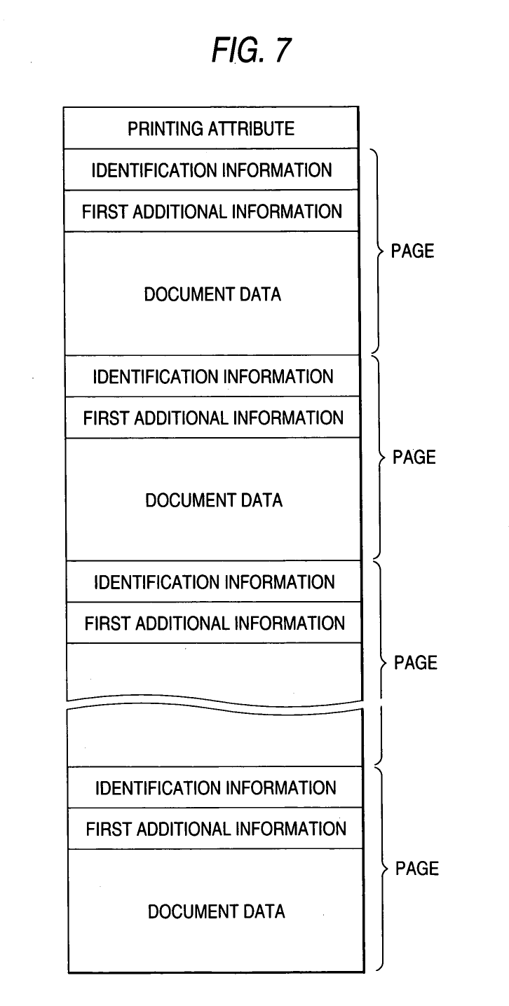

FIG. 7 is a view showing a construction of the document file generated according to the above processes.

As shown in the figure, the printing attribute is allocated to the front portion of the document file. As a result, the document can always be printed with the same printing attribute. In addition, in each of the pages, the identification information of the page and the additional information used for a process for the page are added to the document data.

Now, generation of a combined image of the document image and the code image based on the document file will be described.

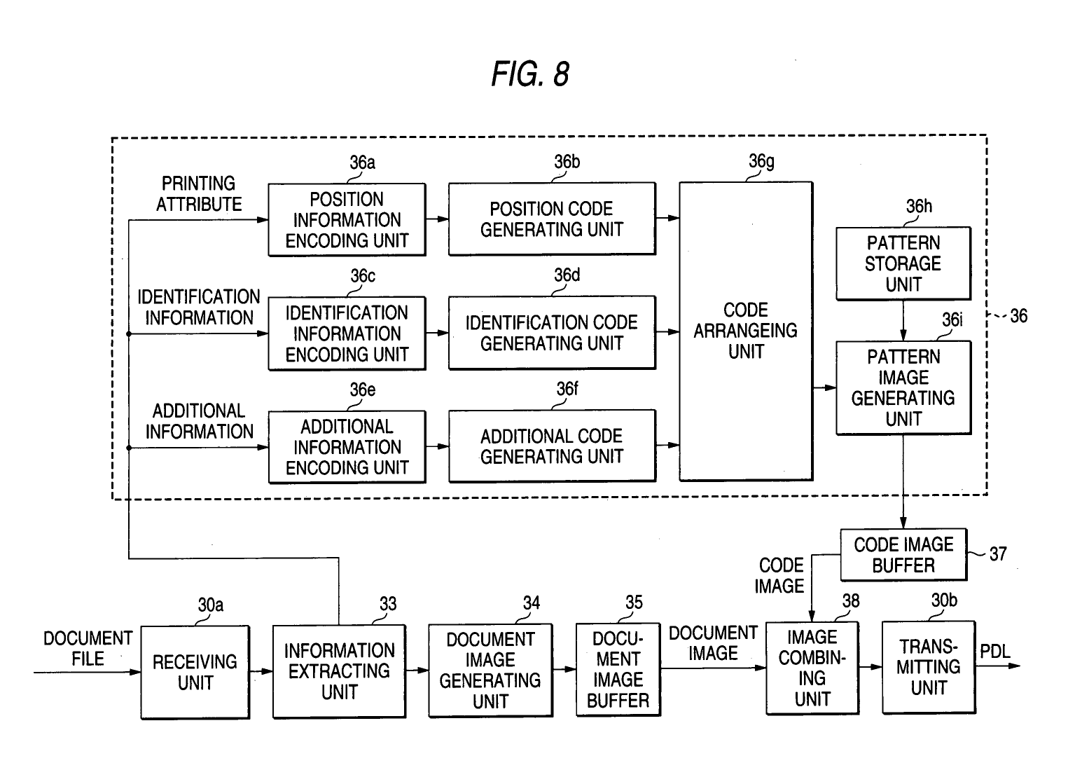

FIG. 8 is a view showing an example of a construction of the identification information managing server 300. In addition, although FIG. 8 shows the construction of the identification information managing server 300 similar to FIG. 2, FIG. 2 shows a construction of registration of the identification information or the like among the construction of the identification information managing server 300, but FIG. 8 shows a construction of image generation. Therefore, a whole construction of the identification information managing server 300 is a combination of the constructions shown in FIGS. 2 and 8.

The identification information managing server 300 comprises a receiving unit 30a, an information extracting unit 33, a document image generating unit 34, a document image buffer 35, a code image generating unit 36, a code image buffer 37, an image combining unit 38, and a transmitting unit 30b.

In addition, the code image generating unit 36 comprises a position information encoding unit 36a, a position code generating unit 36b, an identification information encoding unit 36c, an identification code generating unit 36d, an additional information encoding unit 36e, an additional code generating unit 36f, a code arranging unit 36g, a pattern storage unit 36h, and a pattern image generating unit 361.

The receiving unit 30a receives a document file from a network 900 and transmits the document file to the information extracting unit 33. In addition, in terms of acquiring the document file form the network 900, the receiving unit 30a may be treated as a document acquiring unit.

The information extracting unit 33 extracts information (printing attribute, identification information, and additional information) required for generating the code image from the document file received by the receiving unit 30a.

The document image generating unit 34 generates an image for the electronic document from the information extracted by the information extracting unit 33 and stores the image in the document image buffer 35.

The code image generating unit 36 generates a code image by using the information extracted by the information extracting unit 33 and stores the code image in the code image buffer 37.

The image combining unit 38 combines the document image stored in the document image buffer 35 with the code image stored in the code image buffer 37.

The transmitting unit 30b transmits a command of outputting the image combined by the image combining unit 38 as a PDL (Page Description Language) of which representative one is Post Script to the image forming apparatus 400.

The position information encoding unit 36a encodes the position information according to a predetermined encoding scheme. For the encoding, existing error correction codes, for example, an RS (Reed Solomon) code or a BCH code may be used. In addition, a CRC (Cyclic Redundancy Check) or check sum value of the position information is calculated as an error detection code, and the value may be added as a redundancy bit to the position information. In addition, an M-series code which is a kind of a pseudo noise series may be used as position information. The M-series code is obtained by performing the encoring by using a characteristic in that, in case of a P-th order of M series (series length: 2P-1), when a partial series having a length P is extracted from the M series, a bit pattern occurring in the partial series occurs in the M series at the only one time.

The position code generating unit 36b converts the encoded position information into a format buried as the code information. For example, in order that a third party can not decode the encoded position information, the arrangement of bits in the encoded position information may be exchanged or encrypted by using a pseudo random number. In addition, in a case where the position code is two-dimensionally arranged, the bit value is also two-dimensionally arranged similar to the arrangement of the code.

If the identification information is input, the identification information encoding unit 36c encodes the identification information according to a predetermined encoding scheme. For the encoding, the encoding scheme used for the encoding of the position information may be used.

The identification code generating unit 36d converts the encoded identification information into a format buried as the code information. For example, in order that a third party can not decode the encoded position information, the arrangement of bits in the encoded identification information may be exchanged or encrypted by using a pseudo random number. In addition, in a case where the identification code is two-dimensionally arranged, the bit value is also two-dimensionally arranged similar to the arrangement of the code.

If the additional information is input, the additional information encoding unit 36e encodes the additional information according to a predetermined encoding scheme. For the encoding, the encoding scheme used for the encoding the position information may be used.

Here, the additional information may be constructed with a configuration which can be freely set by a user AP. For example, in some user AP, an original electronic document may be acquired based on the identification information detected from a user image. Therefore, information on an acquiring method at the time of acquiring the original electronic document as the additional information can be set. For example, by using the additional information, conversion may be performed between the acquisition of the original electronic document and the acquisition of the copy of the original electronic document. In addition, conversion may also be performed into only the reading allowance in order to edit the acquired electronic document. In addition, conversion may also be performed into only the printing allowance for the acquired electronic document. Namely, by using the additional information, it is possible to control various operations for each electronic document and each medium. In addition, by using the additional information, access control for the electronic document (for example, a request for inputting user ID and password at the time of accessing the electronic document) can be performed.

On the other hand, a separate user AP may employ information on a copy allowance number (or copy allowance or prohibition) of the printed document as the additional information to control the copy number of the printed document.

The additional code generating unit 36f converts the encoded additional information into a format buried as the code information. For example, in order that a third party can not decode the encoded additional information, the arrangement of bits in the encoded additional information may be exchanged or encrypted by using a pseudo random number. In addition, in a case where the additional code is two-dimensionally arranged, the bit value is also two-dimensionally arranged similar to the arrangement of the code.

The code arranging unit 36g combines the encoded position information, the encoded identification information, and the encoded additional information arranged with a format same as the code and generates a two-dimensional code array corresponding to an output image size. At this time, for the encoded position information, codes obtained by encoding different position information according to arranged positions are used, and for the encoded identification information and the encoded additional information, a code obtained by encoding the same position irrespective of positions is used.

The pattern image generating unit 36i checks bit values of array elements in the two-dimensional code array, acquires bit pattern images corresponding to the bit values from the pattern storage unit 36h, and outputs the code image obtained by imaging the two-dimensional code array.

In addition, these functions are embodied with cooperation of software and hardware resources. More specifically, a CPU (not shown) of the identification information managing server 300 reads a program for embodying functions of the receiving unit 30a, the information extracting unit 33, the document image generating unit 34, the code image generating unit 36, the image combining unit 38, and the transmitting unit 30b from an external memory unit to a main memory unit and executes the program.

Now, operations of the identification information managing server 300 will be described.

In the identification information managing server 300, the receiving unit 30a firstly receives the document file and transmits the received information to the information extracting unit 33.

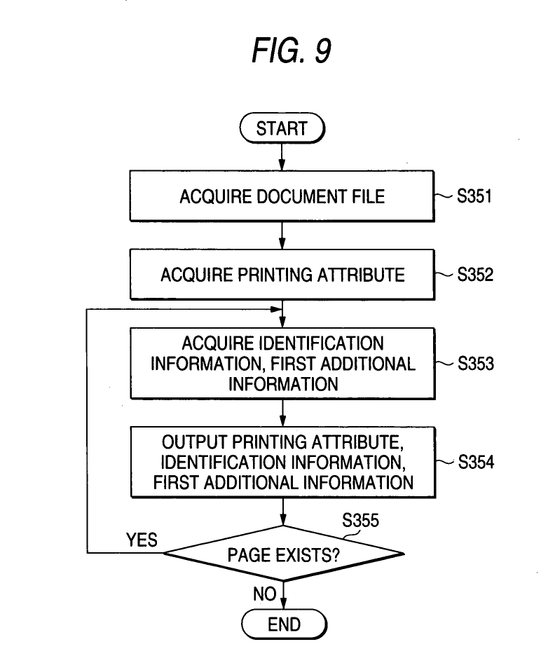

And then, the information extracting unit 33 performs processes shown in FIG. 9.

Namely, the document file is acquired from the receiving unit 30a (Step 351). Next, the printing attribute buried in the front portion of the document file is acquired (Step 352).

After that, the information extracting unit 33 performs processes in Steps 353 to 355 on each of the pages of the document file. More specifically, the identification information and the first additional information are firstly extracted (Step 353). Next, the printing attribute, the identification information for each of the pages, and the first additional information are output to the code image generating unit 36 (Step 354) Next, it is determined whether or not other pages exist (Step 355), and if other pages are determined to exist, Steps 353 and 354 are repeated. If other pages are not determined to exist, the process ends.

By doing so, in the position information encoding unit 36a, the position information corresponding to the printing attribute is encoded, and in the position code generating unit 36b, a position code indicating the encoded position information is generated. In addition, in the identification information encoding unit 36c, the identification information is encoded, and in the identification code generating unit 36d, an identification code indicating the encoded identification information is generated. In addition, in the additional information encoding unit 36e, the addresses of the first additional information and the second additional information are encoded, and in the additional code generating unit 36f, an additional code indicating the encoded additional information is generated.

Next, in the code arranging unit 36g, a two-dimensional code array corresponding to an output image size is generated, and in the pattern image generating unit 36i, a pattern image corresponding to the two-dimensional code array is generated.

On the other hand, the information extracting unit 33 transmits information on the information (information on the electronic document, or the like) in which the information needed for code generation is extracted to the document image generating unit 34, and the document image generating unit 34 generates a document image of the electronic document.

Next, finally, in the image forming unit 38, the document image generated by the document image generating unit 34 and the code image previously generated by the code image generating unit 36 are combined, and the combined image is transmitted to the transmitting unit 30b. By doing so, the transmitting unit 30b transmits the combined image to the image forming apparatus 400.

Now, the image forming apparatus 400 will be described.

The image forming apparatus 400 is a machine for receiving a combined image of the code image and the document image and printing and outputting the received image, and an existing laser printer may be used. The image forming apparatus 400 form the code image with a material (substantially invisible color material) which cannot be discriminated with human eyes and the document image with a material (visible color material) which can be discriminated with human eyes. In addition, a material having a characteristic that a wavelength in a specific infrared range is more absorbed than a wavelength in a visible range is used as the invisible color material, and a material having a characteristic that a wavelength in a visible range is more absorbed is used as the visible color material.

In addition, in the embodiment, although an example of using the invisible color material is described, the embodiment is not limited thereto. For example, the code image may be formed by using carbon black which absorbs a wavelength in an infrared range, and the document image may be formed by using yellow, magenta, and cyan color materials (generally, the color materials have a low absorbance to a wavelength in a infrared range).

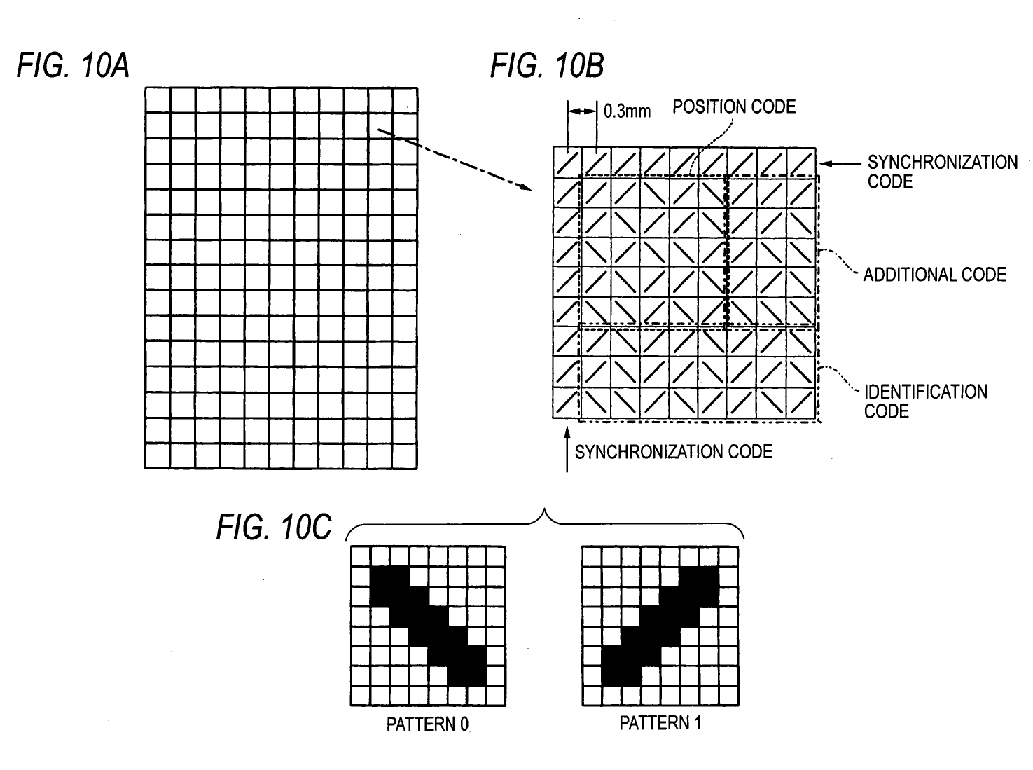

FIGS. 10A to 10C are views for explaining a two-dimensional code image generated by the code image generating unit 36 of the identification information managing server 300 and printed by the image forming apparatus 400. FIG. 10A is a view showing a lattice schematically representing a unit of the two-dimensional code image formed and disposed with the invisible image. In addition, FIG. 10B is a view showing a single unit of the two-dimensional code image where the invisible image is discriminated by infrared light illumination. In addition, FIG. 10C is a view for explaining a slant pattern of backslash “X” and slash “/”.

The two-dimensional code image formed in the image forming apparatus 400 is formed with an invisible toner having a maximum absorbance of, for example, 7% or less at a visible range (400 nm to 700 nm) and an absorbance of, for example, 30% or more at a near-infrared range (800 nm to 1000 nm). In addition, the invisible toner has an average dispersion diameter of 100 nm to 600 nm in order to increase the near-infrared absorbance needed for machine-reading of the image. Here, the terms “visible” and “invisible” are not related to whether or not to be discriminated with human eyes. The “visible” and “invisible” are determined by whether or not an image printed on a medium can be discriminated with presence or absence of a color generating property due to absorbance of a specific wavelength in a visible range.

The two-dimensional code images shown in FIGS. 10A to 10C are formed with the invisible image by which the machine-reading process by the infrared light illumination and the decoding process can be stably performed in a long time and the information can be recorded with a high density thereof. In addition, an invisible image which can be provided to an arbitrary region irrespective of a region to which the visible image on a medium surface is provided for outputting an image is preferred. In the embodiment, the invisible image is formed on the entire surface of one medium surface (paper surface) matched with a size of the printing medium. In addition, an invisible image which can be discriminated according to glossiness difference as seen with human eyes is more preferred. However, the “entire surface” does not denote that the surface includes the four corners of the paper. In the electrophotographic apparatus, since there is generally a region where the printing can not be performed, the invisible image dos not need to be printed in the region.

The two-dimensional code pattern shown in FIG. 10(b) includes a region for storing a position code indicating coordinate positions on the medium, a region for storing an identification code uniquely specifying an electronic document or a printing medium, and a region for storing an additional code used in a user AP. In addition, a region for storing a synchronization code is also included. In addition, as shown in FIG. 10A, a plurality of the two-dimensional code patterns are disposed, and two-dimensional codes in which different position information is stored is disposed in a shape of lattice on the entire surface of one medium surface (paper surface) matched with a size of the printing medium. Namely, a plurality of two-dimensional code patterns shown in FIG. 10B are disposed on the one medium surface, and each of the patterns includes a position code, an additional code, an identification code, and a synchronization code. In addition, in regions of the plurality of position codes, different position information is stored according to the arranged locations thereof. On the other hand, in regions of the plurality of identification codes and additional codes, the same identification information and additional information are stored irrespective of the arranged locations thereof.

In FIG. 10B the position code is disposed within a 5 bit×5 bit rectangular region. Each of bit values is formed a plurality of fine line bitmaps having different rotational angles, and bit value 0 and bit value 1 are represented with slanted patterns (pattern 0 and pattern 1). More specifically, bit 0 and bit 1 are represented by using backslash “Y” and slash“/” having different slopes. The slanted pattern is constructed with 600 dpi in a size of 8×8 pixels, and a leftward rising slanted pattern (pattern 0) and a rightward rising slanted pattern (pattern 1) represent bits value 0 and bit value 1, respectively. Therefore, 1-bit information 0 of 1 can be represented with a single one slanted pattern. By use of the fine line bitmaps constructed with two different slopes, the two-dimensional code pattern having an extremely small noise applied to the visible image and capable of digitalizing and burying a large amount of information with a high density can be provided.

Namely, in the region of the position code shown in FIG. 10B, the position information having a total of 25 bits is stored. Among the 25 bits, 12 bits can be used for am X coordinate encoding process, and 12 bits can be used for a Y coordinate encoding process. The remaining 1 bit may be used for any one of the two encoding processes. If all the 12 bits are used for a position encoding process, 2¹² (4096) positions can be encoded. In a case where each of the slanted patterns is constructed with 8 pixel×8 pixel (600 dpi) as shown in FIG. 10C, since one dot of 600 dpi has a size of 0.0423 mm, a size of the two-dimensional code (including the synchronization code) shown in FIG. 10B has an aspect ratio of about 3 mm (8 pixel×9 bit×0.0423 mm). In a case where the 4096 positions are encoded in an interval of 3 mm, a length of about 12 m can be encoded. Like this, all the 12 bits may be used for the position encoding process. Alternatively, in a case where a detection error of the slanted pattern occurs, a redundant bit for error detection or error correction may be included.

In addition, the identification code is disposed within a 3 bit×8 bit rectangular region and can store the identification information having a total of 24 bits. In a case where the 24 bits are used for the identification information, 224 (about 17,000,000) of identification information can be represented. Similar to the position code, the identification code may also include a redundant bit for error detection or error correction among the 24 bits.

On the other hand, the additional code is disposed within a 5 bit×3 bit rectangular region and can store the identification information having a total of 15 bits. In a case where the 15 bits are used to the additional information, 215 (about 33,000) of additional information can be represented. Similar to the identification code of the position code, the additional code may also include a redundant bit for error detection or error correction among the 15 bits.

In addition, although the two slanted patterns have an angle difference of 90° in the example shown in FIG. 10C, if the angle difference is set to 45°, four types of slanted patterns can be constructed. In such a construction, 2-bit information 0 to 3 can be represented with a single one slanted pattern. Namely, by increasing angel types of the slanted patterns, the number of bits which can be represented can increase.

In addition, although the encoding of the bit values is described by using the slanted patterns in the example shown in FIG. 10C, the pattern which can be selected is not limited to the slanted patterns. A method of encoding ON/OFF of dots or positions of dots according to directions deviated from a reference position may be employed.

Next, characters or the like are written by using the pen device 600 on the medium on which the document image and the code image are printed. At this time, the pen device 600 acquires the identification information, the additional information, and the trajectory information from the medium and transmits the information to the terminal apparatus 700. Next, the terminal apparatus 700 performs an operation of acquiring the electronic document managed by the document managing server 200. In this case, since the correspondence between the identification information and the storage location of the electronic document is managed by the identification information managing server 300, the terminal apparatus 700 sends a query to the identification information managing server 300.

Now, operations of the identification information managing server 300 in response to the query will be described in detail.

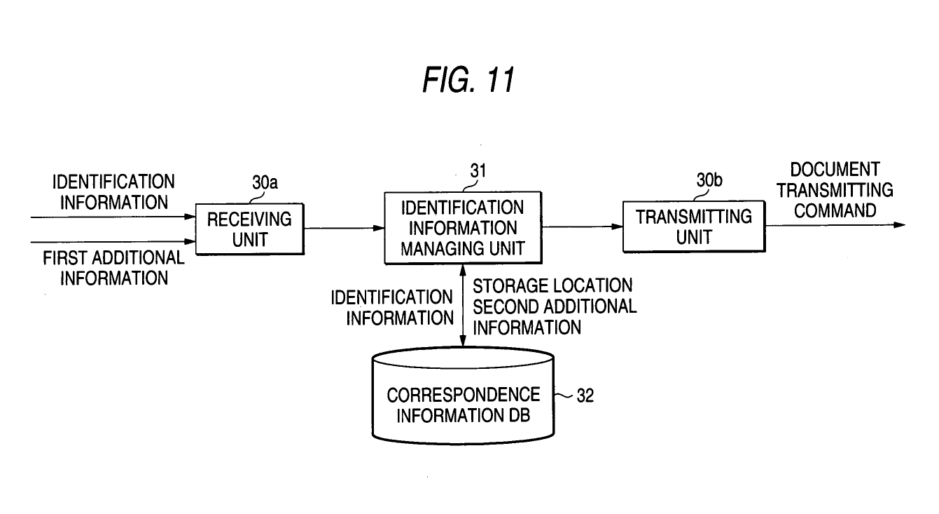

FIG. 11 is a view showing an example of a construction of the identification information managing server 300. Although FIG. 11 shows a construction of the identification information managing server 300 similar to FIGS. 2 and 8, among the construction of the identification information managing server 300, FIG. 2 shows a construction of registration of the identification information or the like and FIG. 8 shows a construction of image generation. However, FIG. 11 shows a construction of a process based on the read image. Therefore, a whole construction of the identification information managing server 300 is a combination of the constructions of FIGS. 2, 8, and 11.

The identification information managing server 300 comprises a receiving unit 30a, an identification information managing unit 31, and a transmitting unit 30b.

The receiving unit 30a receives the identification information and the first additional information from the network 900 and transmits the information to the identification information managing unit 31.

If there is second additional information on an electronic document corresponding to the identification information acquired from the receiving unit 30a, the identification information managing unit 31 performs a process based on the additional information and prepares a document transmission command for transmission to the terminal apparatus 700.

The transmitting unit 30b transmits the document transmission command prepared by the identification information managing unit 31 through the network 900 to the document managing server 200.

In addition, these functions are embodied with cooperation of software and hardware resources. More specifically, a CPU (not shown) of the identification information managing server 300 reads a program for embodying functions of the receiving unit 30a, the identification information managing unit 31, and the transmitting unit 30b from an external memory unit to a main memory unit and executes the program.

Now, operation of the identification information managing server 300 in this case will be described.

In the identification information managing server 300, the receiving unit 30a firstly receives the identification information and the first additional information and transmits the received information to the identification information managing unit 31.

The identification information managing unit 31 acquires the second additional information registered in the correspondence information DB 32 with respect to the identification information transmitted from the receiving unit 30a.

In the embodiment, access limitation is set as the additional information. Therefore, the identification information managing unit 31 determines whether or not the access is limited by referring to the first additional information.

As a result, if the access is not determined to be limited, a document transmitting command for transmitting the electronic document specified by the identification information to the terminal apparatus 700 is prepared.

On the other hand, if the access is determined to be limited, a command is provided to the transmitting unit 30b to transmit an input screen of user ID and password to the terminal apparatus 700. By doing so, the input screen of user ID and password is displayed on the terminal apparatus 700, and a user inputs the user ID and password. The user ID and password are transmitted through the network 900 to the receiving unit 30a, and then, transmitted from the receiving unit 30a to the identification information managing unit 31. Next, the identification information managing unit 31 determines whether or not the transmitted user ID and password are equal to the user ID and password registered in the correspondence information DB 32 with respect to the identification information previously acquired from receiving unit 30a.

As a result, if the user ID and password are not equal to the registered user ID and password, the access to electronic document is refused, and then, the process ends. On the other hand, if the user ID and password are equal to the registered user ID and password, the access to the electronic document is accepted, and then, the document transmitting command for transmitting the electronic document specified by the identification information to the terminal apparatus 700 is prepared.

After that, the prepared document transmitting command is transmitted to the transmitting unit 30b, and the transmitting unit 30b transmits the command through the network 900 to the document managing server 200.

Next, the document managing server 200 transmits the electronic document to the terminal apparatus 700 according to the received document transmitting command.

By doing so, the operation of the embodiment ends.

As described above, in the embodiment, information used for generation of a code image printed together with an image of an electronic document is added to the electronic document in advance and preserved as a document file. According to the construction, it may be possible to generate the code image which is to be printed together with the image of the electronic document without performing a complicated process.

In addition, by storing identification information printed together with the image of the electronic document as a portion of the document file, even though the document file is duplicated, the same identification information may be securely allocated to the document file having the same contents, so that it is possible to prevent disappearance of the identification information.

As described above, according to an aspect of the invention, it may be possible to generate a code image which is to be printed together with an electronic document without performing a complicated process.

The entire disclosure of Japanese Patent Application No. 2005-171710 filed on Jun. 10, 2005 including specification, claims, drawings and abstract is incorporated herein by reference in its entirety.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined solely by the following claims and their equivalents.

What is claimed is:

1. A document processing system comprising:
a document acquiring unit that acquires document data;
an information acquiring unit that acquires information used to generate a code image printed with an image of the document data on a medium; and
a file generating unit that generates an information-added document file by adding the information used to generate the code image to the document data.

2. The document processing system according to claim 1, wherein the information used to generate the code image is identification information for identifying the document data.

3. The document processing system according to claim 2, further comprising:
a managing unit that manages information on a storage location of the document data associated with the identification information.

4. The document processing system according to claim 1, wherein the information used to generate the code image is a printing attribute which is an attribute associated with printing of the document data.

5. The document processing system according to claim 4, further comprising:
a managing unit that manages position information of an image of the document data on the medium determined based on the printing attribute.

6. The document processing system according to claim 1, wherein the information used to generate the code image is additional information used for a user application.

7. A printing system comprising:
a document acquiring unit that acquires a document file formed by adding information to document data;
an information extracting unit that extracts the information from the document file;
a code image generating unit that generates a code image by using the information extracted by the information extracting unit;
a document image generating unit that generates a document image based on the document data included in the document file; and
an image forming unit that forms an image by combining the code image with the document image.

8. The printing system according to claim 7, wherein the image forming unit forms the document image as a visible image and forms the code image as a substantially invisible image.

9. The printing system according to claim 7, wherein the image forming unit forms the document image with color material including yellow, magenta, and cyan color materials and the code image with a material including an infrared-absorbing material.

10. The printing system according to claim 9, wherein the image forming unit forms the document image with a color material including a black color material having a lower infrared absorbance than the infrared-absorbing material.

11. A document file comprising:
first data which is a basis of a document image; and
second data which is converted in a machine-readable code image at the time of printing the document image on a medium and printed together with the document image, wherein the first data and the second data are simultaneously read to be used for printing.

12. The document file according to claim 11, wherein the second data includes identification information for identifying the document data.

13. The document file according to claim 12, wherein the first data is constructed with a document data having a plurality of pages, and
wherein the identification information has a plurality of different identification information on the document data having the plural pages.

14. The document file according to claim 11, further comprising:
third data including attribute information associated with printing of the document image.

15. The document file according to claim 11, wherein the second data includes additional information used for a process for the document data or the medium.

16. The document file according to claim 15, wherein the additional information is attribute information associated with a right to the document file or the medium.

17. A document processing method comprising:
acquiring document data;
acquiring information used to generate a code image printed together with an image of the document data on a medium; and
generating information-added document file by adding the information used to generate the code image to the document data.

18. A storage medium readable by a computer, the strage medium storing a program of instructions executable by the computer to perform a function for generating an image, the function comprising:
acquiring document data;
acquiring information used to generate a code image printed with an image of the document data on a medium; and
generating an information-added document file by adding the information used to generate the code image to the document data.
